(19) United States
(12) Patent Application Publication
(10) Pub. No.: US 2018/0104868 A1
(43) Pub. Date: Apr. 19, 2018

(54) ADIABATIC COOLING OF CASTING MOLDS

(71) Applicant: Weckerle GmbH, Weilheim i.OB (DE)

(72) Inventor: Sven Droste, PeiBenberg (DE)

(21) Appl. No.: 15/719,858

(22) Filed: Sep. 29, 2017

(30) Foreign Application Priority Data
Oct. 18, 2016 (EP) 16194381.6

(51) Int. Cl. B29C 39/38; B29C 39/44

(52) U.S. Cl. CPC B29C 39/38; B29K 2091/00; B29C 39/44

(57) ABSTRACT

A method and an apparatus for cooling of casting molds, in particular for cooling of casting molds for cosmetic products, are described. The apparatus comprises at least one housing with at least one opening for at least partly inserting of at least one casting mold in the at least one housing. It further comprises at least one nozzle for generating of a humid mist within the at least one housing by mixing a gaseous and a liquid medium and for causing a convection within the at least one housing by introducing only the gaseous medium in the at least one housing.

### PRIOR APPLICATIONS

The present application claims priority to European Patent Application No. 16194381.6 filed Oct. 18, 2016, the contents of which are included herein by reference.

### TECHNICAL FIELD

The present invention relates generally to the cooling of casting molds, in particular the cooling of casting molds for cosmetic products.

### BACKGROUND

In the production of cosmetic products, casting molds are used, for example, to receive a heated and flowable mixture of different waxes and additives, which may be referred to as pasty mass. The heated pasty mass is filled into the casting molds in order to subsequently cool and solidify, such that the heated pasty mass takes on a certain shape. The casting molds may, for example, be used for shaping lipstick mines. The shape of the shaped lipstick mines thereby corresponds to the inner contour of the casting mold into which the heated pasty mass has been filled and in which the latter has been cooled and solidified. Cooling may be carried out in a passive or active manner A passive cooling may be carried out, for example, by heat radiation. In this case, the casting mold, which is filled with the heated pasty mass, and which has a higher temperature than its surroundings, emits energy in the form of a heat flow. The resulting energy loss results in the cooling of the surface of the casting mold. Active cooling may, for example, be carried out by heat transfer. In this case, the casting mold, which is filled with the heated pasty mass and which has a higher temperature than its surroundings, is brought into contact with a medium which is colder than the casting mold. As a result of the temperature difference, a heat transfer from the warmer medium, i.e. from the casting mold, to the colder medium begins. During active cooling, the transferred heat quantity per unit of time may be increased by actively causing a circulating of the surface of the casting mold with the cold medium. Such a process may be referred to as an active cooling process.

Various methods and apparatuses are known in the art by ease of which casting molds may be actively cooled. For example, it is described in EP 1 437062 A1 that casting molds are introduced into an environment with cool air in which the casting molds are circulated by the cool air and heat is thus extracted from the casting molds by forced convection. A heat transfer takes place between the casting molds and the cool air.

This type of cooling is, however, little efficient because air in contact with surfaces has a low heat transfer coefficient. The term efficiency generally describes the relationship between the achieved result and the effort expended for it. In the cooling of casting molds, the term efficiency specifically describes the ratio of extracted amount of heat and applied energy. Since a relatively low heat transfer coefficient is observed between air and the surface of a casting mold, a relatively large amount of energy must be applied in order to extract a certain amount of heat from the casting mold. For the extraction of a large amount of heat by ease of air cooling, either a large contact area or a high circulating velocity or a combination of both is required. Air cooling is therefore not very efficient compared to other cooling methods.

It is therefore an object of the present invention to provide a method and an apparatus which do not have the above-mentioned disadvantage. In particular, the method and the apparatus are intended to provide for the most efficient cooling of casting molds.

### SUMMARY

This object is achieved by the method and the apparatus of the independent claims. Advantageous embodiments are described in the dependent claims.

The method according to the invention for cooling of casting molds, in particular for cooling of casting molds for cosmetic products, comprises the at least partly inserting of at least one mold into at least one housing, the generating of a humid mist within the at least one housing by mixing a gaseous medium and a liquid medium by ease of a nozzle and the causing a convection within the at least one housing by introducing only the gaseous medium into the at least one housing by ease of the nozzle. In this case, the housing represents a geometric body which is empty in its interior and thus encloses with its walls a certain area or volume. After the inserting of the casting mold into the housing, the outer surface of the casting mold is thereby exposed to a volume which is delimited by the walls of the housing. In this case, the casting mold may also be only inserted at least partly into the housing, as a result of which, for example, only a part of the outer surface of the casting mold is located within the housing. Within the housing also at least one nozzle is located by ease of which a gaseous and a liquid medium may be mixed and introduced into the housing. The mixing of the gaseous and the liquid medium by ease of the nozzle may also be referred to as vaporizing the liquid medium. By vaporizing the liquid medium, a humid mist is generated within the housing. The humid mist is characterized in that it is moistened and such that wets surfaces exposed to it. The drops of the liquid medium preferably have a drop size between 20 and 40 μm (between 787.4 and 1574.8 μin) and stick to the surfaces within the housing, as a result of which the part of the outer surface of the casting mold, which is located inside the housing, is also wetted with the drops. The outer surface of the casting mold may be hydrophilic, i.e. the drops of the humid mist may easily stick to it. The casting mold may, for example, consist of a hydrophilic material or the outer surface of the casting mold may be coated with a hydrophilic material. The inner surface of the housing, on the other hand, may be hydrophobic, i.e. the drops of the humid mist may hardly stick to it. The drops which have stuck to the outer surface of the casting mold begin to evaporate due to the high temperature of the casting mold. During evaporation, the drops are transferred from the liquid to the gaseous state without boiling. As a result of the state transition during the evaporation of the drops, heat is extracted from the outer surface of the casting mold. This process is also referred to as evaporative cooling or adiabatic cooling. The evaporation of the drops on the outer surface of the casting mold may be accelerated by causing a convection inside the housing, which may also be referred to as forced convection. The accelerated evaporation increases the amount of heat extracted from the outer surface of the casting mold per unit of time. The term convection describes a particle movement in which the moving particles transport heat. The forced convection is caused by the same nozzle with which the humid mist is generated. For this purpose, only the gaseous medium is introduced into the housing by ease of the nozzle. The nozzle may in this case be oriented differently, in order, for example, to control the flow direction of the gaseous medium during the forced convection. The person skilled in the art is aware that the amount of heat which is extracted from the outer surface of the casting mold per unit of time may also be increased by pre-cooling the gaseous and/or the liquid medium before introduction into the housing. The media may thus, for example, be pre-cooled before introduction into the housing either before the supply line, during the supply line or in the nozzle itself.

### BRIEF DESCRIPTION OF THE DRAWINGS

The invention is explained in more detail below with reference to exemplary embodiments with the accompanying drawings. Further details, features and advantages of the subject matter of the invention may be gathered from the exemplary embodiments described. It shows:

FIG. 1 a vertical slice through an exemplary casting mold, filled with a heated pasty mass and an apparatus according to the invention for adiabatic cooling before the adiabatic cooling;

FIG. 2 the exemplary casting mold shown in FIG. 1, filled with a heated pasty mass and partially inserted in the apparatus according to the invention for adiabatic cooling during the adiabatic cooling.

### DETAILED DESCRIPTION

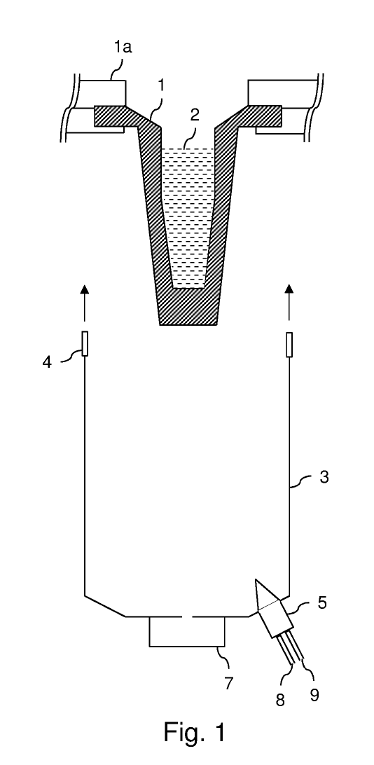

FIG. 1 shows, on the basis of a vertical slice, a casting mold 1, which is filled with a heated pasty mass 2 and which is attached to a structural element 1a, as well as a housing 3, which has a seal 4 on its upwardly directed opening and in which, a nozzle 5 and a separator 7 are arranged in the lower region. The casting mold 1 and the housing 3 are each located in a position in which the casting mold 1 has not yet been inserted into the housing 3. The inserting of the casting mold 1 into the housing 3 is indicated by the vertical arrows. The volume of the housing 3 may be dimensioned in such a way that at least one mold 1 may be inserted into the housing 3. Thus, a plurality of casting molds 1 may also be inserted into the housing 3.

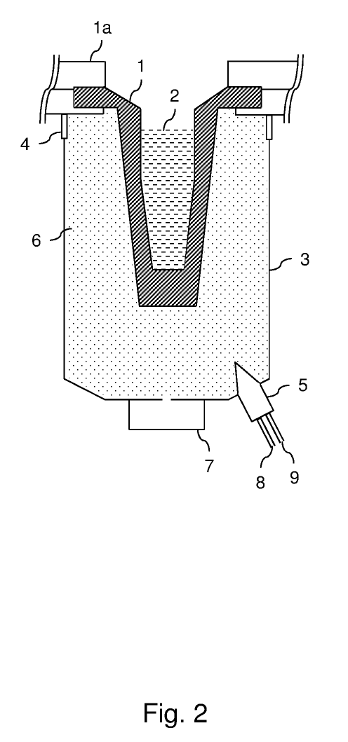

FIG. 2 shows, on the basis of a vertical slice, the casting mold 1, which is filled with a heated pasty mass 2. The casting mold 1 and the housing 3 are each located in a position in which the casting mold 1 is at least partially inserted into the housing 3. The seal 4 seals the interior of the housing 3 against the environment by pressing it against the structural element la to which the casting mold 1 is attached. The humid mist 6 generated by the nozzle 5 is thus enclosed within the housing 3 and wets the hydrophilic surfaces inside the housing 3, such as the outer surface of the casting mold 1. A convection circulating the outer surface of the casting mold 1 may also be caused by the nozzle 5. For generating of the humid mist 6 and for the purpose of causing the forced convection, the nozzle 5 is supplied with a gaseous medium and with a liquid medium via supply lines 8, 9. The excessive gaseous medium may thereby escape into the environment by ease of the separator 7, and the excessive liquid medium may thereby remain in the separator 7 and may be reused.

It will be understood by the person skilled in the art that the exemplary embodiments shown are only exemplary and all elements, modules, components, participants and units shown may be differently designed, but nevertheless may fulfill the basic functionalities described here.

It is clear that the method according to the invention provides for the first time a method by ease of which casting molds are efficiently cooled by ease of a combined evaporation cooling and a forced convection.

Preferably, the at least partly inserting of the at least one casting mold into the at least one housing comprises moving the at least one housing and/or the at least one casting mold. The casting mold may, for example, be moved in such a way that a certain part of its outer surface is inserted into the housing while the housing is not moved. However, the housing may also be moved to enclose or surround a particular portion of the outer surface of the casting mold while the casting mold is not being moved. However, the housing and the casting mold may also be moved such that a certain part of the outer surface of the casting mold is inserted into the housing. In the case of the at least partly inserting of the casting mold into the housing, the housing and the casting mold thus perform a movement relatively to one another. This relative movement may be caused by a movement of the housing and/or of the casting mold. The at least one casting mold may also be attached to at least one structural element, and the at least one housing may also be attached to at least one other structural element. In order to cause the movement of the at least one casting mold and the at least one housing relatively to one another, the at least one structural element to which the at least one housing is attached and/or the at least one structural element to which the at least one casting mold is attached, are moved.

In a further preferred embodiment of the method according to the invention, the method comprises controlling of the flow velocities of the gaseous and the liquid medium out of the at least one nozzle during the production of the humid mist and/or during the causing of the convection. By controlling of the flow velocities, for example, the drop size may be controlled during vaporization. In this case, with increasing flow velocity of the gaseous medium, which is mixed with the liquid medium in the at least one nozzle, the drop size of the liquid medium in the generated humid mist decreases after the mixing. In contrast to large drops, small drops allow a more even distribution of the drops on the outer surface of the at least one casting mold, which leads, for example, to a more uniform extraction of heat during evaporation. However, care must be taken that the drops do not fall below a certain size, since they would otherwise only poorly wet the surface of the at least one casting mold. By controlling of the flow velocities, it is also possible, for example, to control the amount of the liquid medium in the generated humid mist. The higher the flow velocity of the liquid medium, which is mixed with the gaseous medium in the at least one nozzle, the more liquid medium is mixed with the gaseous medium per unit of time, and the more liquid medium is thus introduced into the housing per unit of time. By controlling of the amount of the liquid medium introduced into the housing per unit of time, for example, the duration of time required to wet the outer surface of the at least one casting mold with the liquid medium may be controlled. The more liquid medium is introduced into the housing per unit of time, the faster the outer surface of the at least one casting mold is wetted. When the convection is caused, the flow velocity of the gaseous medium out of the at least one nozzle may be used to control the amount of the gaseous medium, which is introduced into the housing per unit of time and thus circulates around the outer surface of the at least one casting mold. The higher the amount of the gaseous medium circulating around the outer surface of at least one casting mold per unit of time, the more heat is extracted from the outer surface of the at least one casting mold per unit of time. Moreover, by controlling of the flow velocities of the gaseous and the liquid medium out of the at least one nozzle, the amount of drops, which are introduced into the housing after mixing the two media, may also be controlled. Thus, for example, the humidity within the housing may also be controlled.

In a further preferred embodiment of the method according to the invention, the method comprises determining at least one temperature of the at least one casting mold and controlling of the flow velocities of the gaseous and the liquid medium out of the at least one nozzle during the generating of the humid mist and/during said causing of the convection, based on the at least one determined temperature. The determination of a temperature may be the measurement of a temperature. The at least one casting mold, which is filled with the heated pasty mass, initially has a higher temperature compared to its environment. This temperature of the casting mold may be referred to as a first temperature. After the cooling process is completed, the casting mold has a lower temperature than the first temperature. This temperature of the casting mold at the end of the cooling process may be referred to as a second temperature. The second temperature of the casting mold may be determined and compared to a desired value of the second temperature. If the determined second temperature is higher than the desired value of the second temperature, this indicates that not enough heat has been extracted from the casting mold during the cooling process. Based on the determined second temperature of the casting mold, the flow velocities of the gaseous and the liquid medium out of the at least one nozzle may be adapted in such a way that more heat is extracted from the at least one casting mold during the cooling process. For example, during the generating of the humid mist, the flow velocities of the gaseous and the liquid medium may be adapted in such a way that a larger quantity of the humid mist is generated per unit of time. For example, the flow velocity of the gaseous medium may also be increased during the causing of the convection. Conversely, the amount of heat, which is extracted from the at least one casting mold during the cooling process, may be reduced if the determined second temperature is lower than the desired value. This may be implemented, for example, by adapting the flow velocities of the gaseous and the liquid medium out of the at least one nozzle in such a way that a smaller amount of the humid mist is produced. The flow velocity of the gaseous medium during the causing of the convection may also be reduced, so as to extract less heat from the at least one casting mold. Other possibilities are known to the person skilled in the art with which the flow velocities of the gaseous and the liquid medium out of the at least one nozzle may be adapted based on the at least one determined temperature such that a certain amount of heat is extracted from the at least one casting mold during the cooling process. For example, in addition to the second temperature, the temperature change of the casting mold during the cooling process may also be determined. The determined temperature change during the cooling process represents a cooling curve and may be compared to a desired cooling curve. Based on the difference between the determined cooling curve and the desired cooling curve, the flow velocities of the gaseous and the liquid medium out of the at least one nozzle may be controlled such that more or less amount of heat is extracted from the at least one casting mold during the cooling process.

In a further preferred embodiment of the method according to the invention, air may be used as the gaseous medium and water may be used as the liquid medium. Air has the advantage that it may be used from the environment and may easily disappear into the environment. Water has the advantage that it does not, for example, attack the material of the casting mold and, furthermore, does not have a negative effect on the additives and waxes from which the pasty mass consists, since it does not, for example, decrease the surface tension of the mixture of the waxes and additives. However, care must be taken that no germs are formed in the water, which is used. For this purpose, filters or additives may be used, for example.

The above-mentioned object is also achieved by an apparatus according to the invention for cooling of casting molds, in particular for cooling of casting molds for cosmetic products. The apparatus comprises at least one housing with at least one opening for at least partly inserting at least one casting mold into the at least one housing and at least one nozzle for generating a humid mist within the at least one housing by mixing a gaseous and a liquid medium and for causing a convection within the at least one housing by introducing only the gaseous medium into the at least one housing. For example, the apparatus may be designed in such a way that the at least one opening of the at least one housing faces upwards so that the at least one casting mold may be introduced into the housing from above by ease of a vertical movement.

In a further preferred embodiment of the apparatus according to the invention, the at least one nozzle may be adapted to introduce the gaseous and the liquid medium into the at least one housing. For example, the at least one nozzle may be positioned at different positions within the housing in order to provide a targeted wetting of the outer surface of the at least one casting mold with the generated humid mist and, for example, to selectively direct the flow of the gaseous medium during the forced convection. The nozzle may also be adapted in its orientation in order, for example, to direct the flow in a targeted manner during the forced convection. The gaseous medium and the liquid medium are supplied from outside the housing via connections which are connected to the nozzle.

In a further preferred embodiment of the apparatus according to the invention, the at least one nozzle may be a pressure vaporizer with a flat beam angle of 95° and external mixture. The external mixture allows independent control of the flow velocities of the two media. The principle of mixing and vaporizing the two media is based on the shearing action of the two media on impact.

In a preferred embodiment of the apparatus according to the invention, the apparatus also comprises at least one separator through which the excessive gaseous medium may leak from the at least one housing and in which the excessive liquid medium from the at least one housing may stay behind. The separator may be installed at the lowest point of the housing, for example at its bottom. In the generating of the humid mist and in the causing of the convection, a certain amount of the gaseous and of the liquid medium is introduced into the housing from the outside. In order to counteract a pressure increase within the housing, the excessive gaseous medium may leak from the interior of the housing through the separator. The excessive liquid medium passes into the separator under the action of the gravity and remains in the separator. The liquid medium may, for example, be collected in a removable container in order to be reused. However, the separator may also return the liquid medium directly to the nozzle or into a reservoir.

In a further preferred embodiment of the apparatus according to the invention, the apparatus comprises a means for controlling the flow velocities of the gaseous and the liquid medium from the at least one nozzle in the generating of the humid mist and/or in the causing of the convection. The gaseous and the liquid medium may in each case be fed from a reservoir by a feeding line to the inlet of the nozzle. In the reservoir, an overpressure may be generated by pumps. However, the gaseous and the liquid medium may also be pumped directly to the nozzle inlet. The flow velocities of the gaseous and liquid medium out of the at least one nozzle are essentially dependent on the differential pressure between the nozzle inlet and the nozzle outlet, as well as on the cross-sectional area of the nozzle openings through which the respective medium flows. If the cross-sectional area of the nozzle openings is assumed to be constant, the respective flow velocities of the gaseous and the liquid medium out of the at least one nozzle may thus be controlled by the control of the respective pressure difference between the nozzle inlet and the nozzle outlet. The means for controlling of the flow velocity may, for example, be at least one pressure regulating valve, which, in each case, is mounted in the supply line between the reservoir and the nozzle inlet. The pressure at the nozzle inlet may be controlled by the respective pressure control valve by throttling the respective supply line from the respective reservoir. The pump performance of the pumps, which pump the gaseous and the liquid medium to the nozzle inlet, may also be controlled. Other means, with which the flow velocity may be controlled, are known to the person skilled in the art. For example, simple flow valves, which are based on the principle of simple throttle valves, may be used in front of the nozzle inlet.

In a further preferred embodiment of the apparatus according to the invention, the apparatus comprises a means for moving the at least one housing and/or the at least one casting mold. The at least one housing and/or the at least one casting mold may be attached, for example, to at least one structural element. The means for moving the at least one housing and/or the at least one casting mold and/or the at least one structural element may, for example, be at least one lifting mechanism. The at least one lifting mechanism may, for example, be driven by at least one stepping motor. In this case, a stepping motor is a multiphase synchronous motor, which is pulse-controlled by ease of an electronic circuit. In the case of a pulsed drive, the motor shaft carries out a rotation about a specific angle of rotation, the so-called step angle. The means with which the at least one lifting mechanism is set in motion may also be a servomotor. A servomotor is an electric motor, which can control the angular position and the rotational speed of the motor shaft by ease of a sensor for the position determination. Other means are known to a person skilled in the art for setting the at least one housing and/or the at least at least one casting mold and/or the at least one structural element in motion, and for inserting the at least one casting mold at least partially into the at least one housing. For example, hydraulic or pneumatic actuators may also be used for this purpose.

In a further preferred embodiment of the apparatus according to the invention, the apparatus comprises a means for determining at least one temperature of the at least one casting mold and a means for controlling of the flow velocities of the gaseous and the liquid medium out of the at least one nozzle during the generating of the humid mist and/or in the causing of the convection within the enclosure, based on the at least one determined temperature. The temperature of the casting mold may, for example, be determined with at least one pyrometer, which contactlessly measures the heat radiation, which is emitted from the outer surface of the casting mold, is determined based on a known emission grade from the outer surface of the casting mold. In the course of a measurement, the pyrometer detects a specific area on the outer surface of the casting mold, which may be referred to as a measuring surface, the measuring surface being generally smaller than the outer surface of the casting mold. According to the invention, the pyrometer may be integrated into the apparatus such that it is at least movable around an axis and/or along an axis, whereby the pyrometer may be oriented differently for different measurements in order to measure the heat radiation from different measuring surfaces on the outer surface of the casting mold. The pyrometer may also be oriented to measure the heat radiation from different measuring surfaces on the outer surface of various casting molds. The pyrometer may also be oriented such that the temperature of the surface of the heated pasty mass may be determined. The alignment of the pyrometer may, for example, be carried out by ease of a stepping motor. Alternatively, the pyrometer may also be aligned by ease of a servomotor. For example, hydraulic or pneumatic actuators may also be used for the alignment of the pyrometer. The at least one value of the determined temperature may, for example, be transmitted to a microcontroller, which, based on the determined temperature of the at least one measuring surface of the at least one casting mold or of the heated pasty mass, may control the flow velocities of the gaseous and the liquid medium out of the at least one nozzle during the generating of the humid mist and/or during the causing of the convection within the housing. The microcontroller may also provide instructions with which the at least one lifting mechanism, which moves the at least one housing and/or the at least one casting mold and/or the at least one structural element, may be set in motion. The person skilled in the art will appreciate that other means for determining a temperature may also be used. For example, the temperature of the at least one casting mold or of the heated pasty mass may also be determined by means of temperature sensors within the at least one casting mold, wherein, for example, the electrical resistance in the temperature sensors is dependent on the temperature. The person skilled in the art is aware that the determination or measurement of the temperature of the at least one casting mold or of the heated pasty mass may be determined parallel to adiabatic cooling, i.e. during adiabatic cooling. Based on this, the flow velocities of the gaseous and the liquid medium out of the at least one nozzle into the housing may be controlled during the generating of the humid mist and/or during the causing of the convection during adiabatic cooling. For this purpose, for example, pressure control valves may be used which react to signals from the microcontroller and, depending on the pressure, adjust the pressure at the nozzle inlet. Pumps may also be used, which pump the gaseous and the liquid medium directly to the nozzle inlet and whose pumping power is based on signals from the microcontroller and the pressure at the nozzle inlet is adjusted as a function thereof.

In a further preferred embodiment of the apparatus according to the invention, the at least one opening in the at least one housing comprises a seal. In the case of the at least partial inserting of the at least one casting mold into the at least one housing, the seal may, for example, come into contact with the casting mold or with the structural element to which the casting mold is attached, thus sealing the interior of the housing against the environment. In this case, it is also possible for only a part of the seal to come into contact with the casting mold or with the structural element to which the casting mold is attached. The structural element to which the casting mold is attached may also comprise a protruding element. In this case, the seal may, for example, at least partially be introduced into the protruding element and come into contact with the protruding element. However, it is also possible for the protruding element to be introduced into the seal. The seal may, for example, be a V-ring seal. For example, the seal may be made of rubber, such as, for example, nitrile rubber (NBR). The seal may, for example, be used in a temperature range of −40° C. to 80° C. (−40° F. to 176° F.). In addition, the seal may, for example, have a specific Shore hardness which is suitable for the required seal. This Shore hardness may be a Shore-A hardness of 70. It will be appreciated by the person skilled in the art that other sealing forms and sealing materials may also be used.

1. A method for cooling of casting molds, in particular for cooling of casting molds for cosmetic products, the method comprising:
at least partly inserting of at least one casting mold into at least one housing;
generating a humid mist within the at least one housing by mixing of a gaseous and a liquid medium by ease of a nozzle; and
causing a convection within the at least one housing by introducing only the gaseous medium into the at least one housing by ease of the nozzle.

2. The method according to claim 1, wherein the at least partly inserting of the at least one casting mold into the at least one housing comprises a moving of the at least one housing and/or the at least one casting mold.

3. The method according to claim 1, further comprising:
controlling of the flow velocities of the gaseous and the liquid medium out of the at least one nozzle during the generating of the humid mist and/or during said causing of the convection.

4. The method according to claim 1, further comprising:
determining at least one temperature of the at least one casting mold; and
controlling of the flow velocities of the gaseous and the liquid medium out of the at least one nozzle during the generating of the humid mist and/or during said causing of the convection, based on the at least one determined temperature.

5. The method according to claim 1, wherein air is used as gaseous medium and water is used as liquid medium.

6. An apparatus for cooling of casting molds, in particular for cooling of casting molds for cosmetic products, the apparatus comprising:
at least one housing with at least one opening for at least partly inserting of at least one casting mold into the at least one housing; and
at least one nozzle for generating of a humid mist within the at least one housing by mixing a gaseous and a liquid medium and for causing a convection within the at least one housing by introducing only the gaseous medium into the at least one housing.

7. The apparatus according to claim 6, wherein the at least one nozzle is adapted to introduce the gaseous and the liquid medium into the at least one housing.

8. The apparatus according to claim 6, wherein the at least one nozzle is a pressure vaporizer with external mixing.

9. The apparatus according to claim 6, further comprising:
at least one separator, with which the excessive gaseous medium leaks from the at least one housing and in which the excessive liquid medium from the at least one housing stays behind.

10. The apparatus according to claim 6, further comprising:
a means for controlling of the flow velocities of the gaseous and the liquid medium out of the at least one nozzle during the generating of the humid mist and/or during said causing of the convection.

11. The apparatus according to claim 6, further comprising:
a means for moving the at least one housing and/or the at least one casting mold.

12. The apparatus according to claim 6, further comprising:
a means for determining at least one temperature of the at least one casting mold; and
a means for controlling of the flow velocities of the gaseous and the liquid medium out of the at least one nozzle during the generating of the humid mist and/or during said causing of the convection within the housing, based on the at least one determined temperature.

13. The apparatus according to claim 6, wherein the at least one opening in the at least one housing comprises a seal.
